(19) United States
(12) Patent Application Publication
(10) Pub. No.: US 2009/0322972 A1
(43) Pub. Date: Dec. 31, 2009

(54) OPTICAL UNIT AND HEAD MOUNTED DISPLAY APPARATUS

(75) Inventor: Takahisa Ando, Ikoma-City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi City (JP)

(21) Appl. No.: 12/446,630

(22) PCT Filed: Oct. 22, 2007
(86) PCT No.: PCT/JP2007/070530

§ 371 Date: May 21, 2009

(30) Foreign Application Priority Data
Oct. 24, 2006 (JP) 2006-289089
Oct. 15, 2007 (JP) 2007-267826

(51) Int. Cl. G02F 1/1335; G02B 5/30

(52) U.S. Cl. 349/11; 359/499; 359/485

(57) ABSTRACT

An optical unit 100 includes: a liquid crystal panel 110 configured to emit image light; a diaphragm 130 having a pin hole 131 at a focal position where the image light emitted from the liquid crystal panel 110 is focused; a PBS film 140 having a tilt of approximately 45° with respect to an optical axis of the image light passed through the pin hole 131; a ¼λ-retardation film 150 having a tilt of approximately 90° with respect to the optical axis of the image light passed through the pin hole 131 and being configured to convert the polarization state of the image light passed through the pin hole 131 from linear polarization to circular polarization; a concave mirror 160 configured to reflect the image light transmitted through the ¼λ-retardation film 150 toward the ¼λ-retardation film 150; and an eyepiece lens 200 configured to focus the image light reflected by the concave mirror 160 on the eyeball.

### TECHNICAL FIELD

The present invention relates to an optical unit and a head mounted display apparatus configured to focus image light emitted from an imager on the eyeball.

### BACKGROUND ART

There has heretofore been known a head mounted display apparatus configured to focus image light emitted from an imager on the eyeball (for example, Japanese Patent Publication No. Heisei 7 (1995)-2B0292 (Claim 1, FIG. 8 and the like)). The head mounted display apparatus is mounted on the head of a user so that the user can see an image in any posture.

Meanwhile, when the user has weak eyesight, the focusing function of the lens of the eyeball is low. For this reason, the user cannot properly form an image on the retina unless image light is sufficiently focused on the pupil of the eyeball. To address this issue, there has been proposed a method for focusing the image light emitted from the imager on a pin hole and then focusing the image light passed through the pin hole on the pupil of the eyeball.

Here, when the pin hole is provided close to the eyeball, a field of view of the user is narrowed. Thus, it is preferable that the image light spread after passing through the pin hole should be focused again on the pupil of the eyeball.

However, in order to homogenize the image light spread after passing through the pin hole, a sufficient distance from the pin hole to an eyepiece lens needs to be secured. When the sufficient distance from the pin hole to the eyepiece lens is secured, the head mounted display apparatus is increased in size.

Since the head mounted display apparatus is mounted on the head of the user as described above, a size increase of the device is undesirable.

### DISCLOSURE OF THE INVENTION

As an aspect of the present invention, an optical unit includes: an imager (liquid crystal panel 110) configured to emit image light; a diaphragm (diaphragm 130) having an aperture (pin hole 131) at a focal position where the image light emitted from the imager is focused; a first PBS film (PBS film 140) having a tilt of approximately 45° with respect to an optical axis of the image light passed through the aperture; a first retardation film (¼λ-retardation film 150) having a tilt of approximately 90° with respect to the optical axis of the image light passed through the aperture and being configured to convert the polarization state of the image light passed through the aperture from linear polarization to circular polarization; a first concave mirror (concave mirror 160) configured to reflect the image light transmitted through the first retardation film toward the first retardation film; and an eyepiece lens (eyepiece lens 200) configured to focus the image light reflected by the first concave mirror on the eyeball.

According to the aspect described above, even a weak-eyesight person having a lowered focusing function of a lens of the eyeball can see an image since the image light condensed on the aperture provided in the diaphragm is focused on the eyeball by the eyepiece lens. Moreover, since the first PBS film and the first concave mirror reflect the image light, an optical path length between the diaphragm and the eyepiece lens can be increased and the image light can be sufficiently homogenized while an increase in a device size is suppressed. Furthermore, the optical unit employs a configuration in which the image light is transmitted twice through the first retardation film so as to allow the first retardation film to convert the polarization state of the image light from linear polarization to circular polarization and then to convert the polarization state of the image light from circular polarization to linear polarization. By employing such a configuration, the polarization state of the image light is rotated approximately 90° and the image light converted from S-polarized light into P-polarized light or the image light converted from P-polarized light into S-polarized light can be extracted.

In the aspect described above, when the image light passed through the aperture is S-polarized light, the eyepiece lens is provided at a position opposed the first concave mirror across the first PBS film.

In the aspect described above, when the image light passed through the aperture is P-polarized light, the eyepiece lens is provided on the same side as the first concave mirror, the side being defined by the first PBS film as a boundary.

In the aspect described above, the optical unit further includes: a second retardation film (¼λ-retardation film 170) configured to convert the polarization state of the image light transmitted through the first PBS film from linear polarization to circular polarization, the second retardation film provided at a position across the first PBS film from the first concave mirror when the image light passed through the aperture is S-polarized light; and a reflecting mirror (reflecting mirror 180) configured to reflect the image light transmitted through the second retardation film toward the second retardation film. When the image light passed through the aperture is S-polarized light, the eyepiece lens is provided on the same side as the reflecting mirror, the side being defined by the first PBS film as a boundary.

In the aspect described above, the optical unit further includes: a second retardation film (¼λ-retardation film 170) configured to convert the polarization state of the image light reflected by the first PBS film from linear polarization to circular polarization, the second retardation film provided on the same side as the first concave mirror, the side being defined by the first PBS film as a boundary when the image light passed through the aperture is P-polarized light; and a reflecting mirror (reflecting mirror 180) configured to reflect the image light transmitted through the second retardation film toward the second retardation film. When the image light passed through the aperture is P-polarized light, the eyepiece lens is provided at a position opposed the reflecting mirror across the first PBS film.

In the aspect described above, the optical unit further includes: a second PBS film (PBS film 210) having a tilt of approximately 45° with respect to the optical axis of the image light emitted from the imager; a third retardation film (¼λ-retardation film 220) configured to convert the polarization state of the image light reflected by the second PBS film or the image light transmitted through the second PBS film from linear polarization to circular polarization; and a second concave mirror (concave mirror 230) configured to reflect the image light transmitted through the third retardation film toward the third retardation film. The second concave mirror focuses the image light on the aperture.

As an aspect of the present invention, a head mounted display apparatus mounted on the head of a user includes: an annular member having an annular shape mounted on the head of the user; an adjuster configured to adjust a gap formed between a back of the head of the user and an inner surface of the annular member, the adjuster provided in the annular member on the back side of the head of the user; a nose pad provided in the annular member in front of the head of the user and pressed against the nose of the user; a display unit disposed in front of an eyeball of the user; and a connection member configured to connect the annular member with the display unit, the connection member provided in the annular member in front of the head of the user. The display unit includes: an imager configured to emit image light; a light source configured to irradiate the imager with light; a diaphragm having an aperture at a focal position where the image light emitted from the imager is focused; a first PBS film having a tilt of approximately 45° with respect to an optical axis of the image light passed through the aperture; a first retardation film having a tilt of approximately 90° with respect to the optical axis of the image light passed through the aperture, and being configured to convert the polarization state of the image light passed through the aperture from linear polarization to circular polarization; a first concave mirror configured to reflect the image light transmitted through the first retardation film toward the first retardation film; and an eyepiece lens configured to focus the image light reflected by the first concave mirror on the eyeball.

In the aspect described above, the head mounted display apparatus further includes ear pads provided to extend downward from the annular member at the lateral sides of the head of the user, and pressed against bases of the ears of the user.

In the aspect described above, the connection member has a first arm provided on the annular member side and a second arm provided on the display unit side, and the first arm rotatably supports the second arm.

In the aspect described above, the annular member rotatably supports the first arm.

In the aspect described above, the second arm rotatably supports the display unit.

### BRIEF DESCRIPTION OF THE DRAWINGS

FIG. 1 is a diagram showing an outline of a head mounted display apparatus 20 according to a first embodiment.

FIG. 2 is a diagram showing a configuration of an optical unit 100 according to the first embodiment.

FIG. 3 is a diagram showing a configuration of an optical unit 100 according to a second embodiment.

FIG. 4 is a diagram showing a configuration of an optical unit 100 according to a third embodiment.

FIG. 5 is a diagram showing a configuration of an optical unit 100 according to a fourth embodiment.

FIG. 6 is a diagram showing a configuration of an optical unit 100 according to a fifth embodiment.

FIG. 7 is a diagram showing a configuration of an optical unit 100 according to a sixth embodiment.

FIG. 8 is a diagram showing a configuration of an optical unit 100 according to a seventh embodiment.

FIG. 9 is a diagram showing a configuration of an optical unit 100 according to an eighth embodiment.

FIG. 10 is a diagram for explaining a comparative example according to a ninth embodiment.

FIG. 11 are a diagrams for explaining an example according to the ninth embodiment.

FIG. 12 are diagrams showing a configuration of a head mounted display apparatus 20 according to a tenth embodiment.

FIG. 13 is a diagram showing a configuration of a connection member 450 according to the tenth embodiment.

FIG. 14 is a diagram showing a configuration of an image control BOX 500 according to an eleventh embodiment.

FIG. 15 is a diagram showing a configuration of a display unit 460 according to another embodiment.

FIG. 16 is a diagram showing a configuration of a display unit 460 according to another embodiment.

FIG. 17 are diagrams showing a configuration of a display unit 460 according to another embodiment.

### BEST MODES FOR CARRYING OUT THE INVENTION

Hereinafter, head mounted display apparatuses according to embodiments of the present invention will be described with reference to the drawings. Note that, in the following description of the drawings, the same or similar parts will be denoted by the same or similar reference numerals.

However, it should be noted that the drawings are schematic and proportions of respective dimensions and the like are different from actual ones. Therefore, specific dimensions and the like should be determined by taking into consideration the following description. Moreover, as a matter of course, the drawings also include portions in which dimensional relationships and proportions are different among the drawings.

### First Embodiment

### (Outline of Head Mounted Display Apparatus)

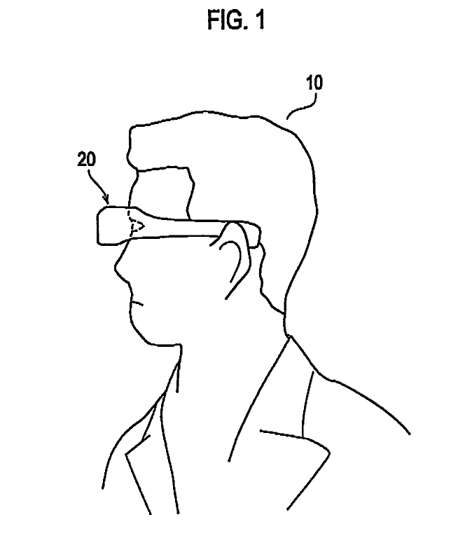

Hereinafter, an outline of a head mounted display apparatus according to a first embodiment will be described with reference to the drawing. FIG. 1 is a diagram showing an outline of a head mounted display apparatus 20 according to the first embodiment.

As shown in FIG. 1, the head mounted display apparatus 20 is configured to be mounted on the head of a user 10. The head mounted display apparatus 20 may be configured to be worn as eyeglasses or may be configured to be put on as a helmet.

Note that, in the first embodiment, the head mounted display apparatus 20 is a device configured to focus image light on the eyeball of the user 10. Particularly, in the first embodiment, the head mounted display apparatus 20 is a device configured to enable the user 10 to see the image light even if the user 10 is a weak-eyesight person. Note that the user 10 can see an image in any posture.

### (Configuration of Optical Unit)

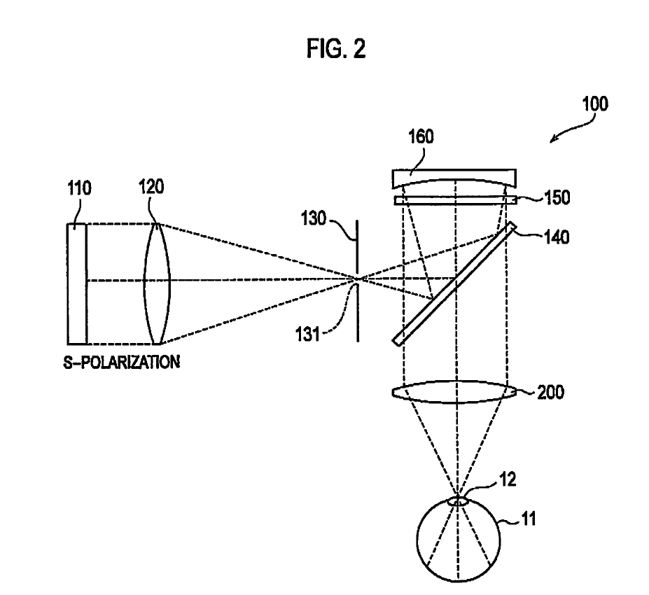

Hereinafter, a configuration of an optical unit according to the first embodiment will be described with reference to the drawing. FIG. 2 is a diagram showing a configuration of an optical unit 100 according to the first embodiment.

As shown in FIG. 2, the optical unit 100 includes a liquid crystal panel 110, a condenser lens 120, a diaphragm 130, a PBS film 140, a ¼λ-retardation film 150, a concave mirror 160 and an eyepiece lens 200.

The liquid crystal panel 110 is an imager configured to emit image light by modulating light emitted by a light source (not shown). The liquid crystal panel 110 emits S-polarized image light.

The condenser lens 120 condenses the image light emitted by the liquid crystal panel 110. Specifically, the condenser lens 120 condenses the image light on an aperture (pin hole 131) provided in the diaphragm 130.

The diaphragm 130 is formed of a light shielding member. The diaphragm 130 has the pin hole 131 through which the image light condensed by the condenser lens 120 passes. The diaphragm 130 is disposed so as to allow the pin hole 131 to overlap with a focal position of the condenser lens 120.

The PBS film 140 is a PBS (Polarized Beam Splitter) film configured to separate the light into reflected light and transmitted light according to a polarization direction of the light. Specifically, the PBS film 140 transmits P-polarized image light therethrough and reflects the S-polarized image light. The PBS film 140 has a tilt of approximately 45° with respect to an optical axis of the image light passed through the pin hole 131. Note that the PBS film 140 reflects the S-polarized image light passed through the pin hole 131 toward the concave mirror 160, and transmits the P-polarized image light returned after being reflected by the concave mirror 160 therethrough toward the eyepiece lens 200.

The ¼λ-retardation film 150 is a retardation film configured to convert the polarization state of the light from linear polarization to circular polarization and to convert the polarization state of the light from circular polarization to linear polarization. The ¼λ-retardation film 150 has a tilt of approximately 90° with respect to the optical axis of the image light passed through the pin hole 131 (in FIG. 2, the optical axis of the image light reflected by the PBS film 140). The ¼λ-retardation film 150 is provided on the side where the image light is reflected by the PBS film 140.

The concave mirror 160 reflects the image light transmitted through the ¼λ-retardation film 150 toward the ¼λ-retardation film 150. The concave mirror 160 homogenizes the image light by reflecting the image light.

As described above, the image light reflected by the PBS film 140 is transmitted through the ¼λ-retardation film 150, reflected by the concave mirror 160 and then transmitted again through the ¼λ-retardation film 150. In other words, the image light reflected by the PBS film 140 is transmitted twice through the ¼λ-retardation film 150. Accordingly, the polarization direction of the image light is rotated approximately 90° and the polarization state of the image light is changed from S-polarization to P-polarization or from P-polarization to S-polarization.

Therefore, the polarization direction of the image light reflected by the concave mirror 160 and then transmitted again through the ¼λ-retardation film 150 is a P-polarization direction. As a result, the image light reflected by the concave mirror 160 is transmitted through the PBS film 140.

The eyepiece lens 200 focuses the image light reflected by the concave mirror 160 on a pupil 12 of an eyeball 11. The eyepiece lens 200 causes the image light focused on the pupil 12 to form an image on a retina of the eyeball 11. Since the image light reflected by the concave mirror 160 is transmitted through the PBS film 140, the eyepiece lens 200 is provided at a position opposed the concave mirror 160 across the PBS film 140.

### (Operations and Effects)

According to the optical unit 100 of the first embodiment, the eyepiece lens 200 enables even a weak-eyesight person having a lowered focusing function of a lens of the eyeball 11 to see an image since the image light condensed on the pin hole 131 provided in the diaphragm 130 is focused on the pupil 12 of the eyeball 11. Moreover, since the PBS film 140 and the concave mirror 160 reflect the image light, an optical path length between the diaphragm 130 and the eyepiece lens 200 can be increased and the image light can be sufficiently homogenized while an increase in a device size is suppressed. Furthermore, the optical unit 100 employs a configuration in which the image light is transmitted twice through the ¼λ-retardation film 150 so as to allow the ¼λ-retardation film 150 to convert the polarization state of the image light from linear polarization to circular polarization and then to convert the polarization state of the image light from circular polarization to linear polarization. By employing such a configuration, the polarization state of the image light is rotated approximately 90° and the image light converted from S-polarized light into P-polarized light or the image light converted from P-polarized light into S-polarized light can be extracted.

### Second Embodiment

Hereinafter, a second embodiment will be described with reference to the drawing. The following description will be mainly given of differences between the first embodiment described above and the second embodiment.

In the first embodiment described above, the image light emitted from the liquid crystal panel 110 (the image light passed through the pin hole 131) is the S-polarized light On the other hand, in the second embodiment, image light emitted from a liquid crystal panel 110 (image light passed through a pin hole 131) is P-polarized light.

### (Configuration of Optical Unit)

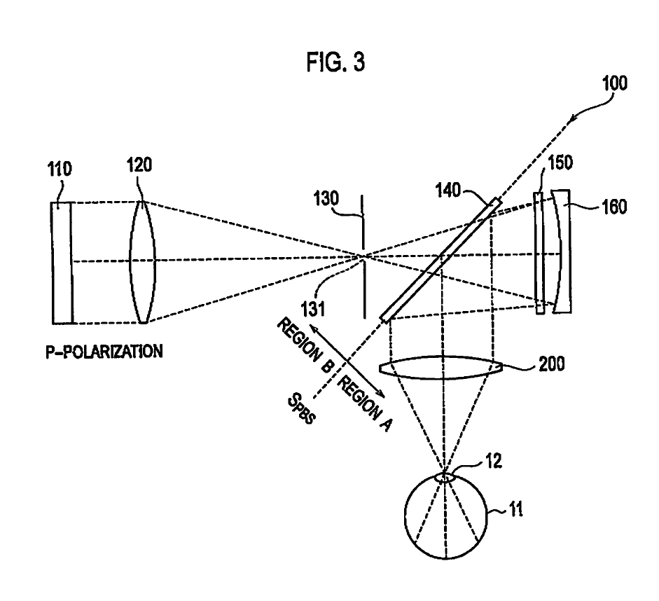

Hereinafter, a configuration of an optical unit according to the second embodiment will be described with reference to the drawing. FIG. 3 is a diagram showing a configuration of an optical unit 100 according to the second embodiment. It should be noted that, in FIG. 3, the same parts as those shown in FIG. 2 are denoted by the same reference numerals.

As shown in FIG. 3, the liquid crystal panel 110 emits P-polarized image light and a condenser lens 120 condenses the P-polarized image light on the pin hole 131.

A PBS film 140 has a tilt of approximately 45° with respect to an optical axis of the image light passed through the pin hole 131. Note that the PBS film 140 transmits the P-polarized image light passed through the pin hole 131 therethrough toward a concave mirror 160 and reflects S-polarized image light returned after being reflected by the concave mirror 160 toward an eyepiece lens 200.

A ¼λ-retardation film 150 has a tilt of approximately 90° with respect to the optical axis of the image light passed through the pin hole 131 (in FIG. 3, the optical axis of the image light transmitted through the PBS film 140). The ¼λ-retardation film 150 is provided on the side where the image light is transmitted through the PBS film 140.

The concave mirror 160 reflects the image light transmitted through the ¼λ-retardation film 150 toward the ¼λ-retardation film 150. The concave mirror 160 homogenizes the image light by reflecting the image light.

As described above, the image light transmitted through the PBS film 140 is transmitted through the ¼λ-retardation film 150, reflected by the concave mirror 160 and then transmitted again through the ¼λ-retardation film 150. In other words, the image light transmitted through the PBS film 140 is transmitted twice through the ¼λ-retardation film 150. Accordingly, a polarization direction of the image light is rotated approximately 90° and the polarization state of the image light is changed from S-polarization to P-polarization or from P-polarization to S-polarization.

Therefore, the polarization direction of the image light reflected by the concave mirror 160 and then transmitted again through the ¼λ-retardation film 150 is an S-polarization direction. As a result, the image light reflected by the concave mirror 160 is reflected by the PBS film 140.

The eyepiece lens 200 focuses the image light reflected by the concave mirror 160 on a pupil 12 of an eyeball 11. The eyepiece lens 200 causes the image light focused on the pupil 12 to form an image on a retina of the eyeball 11. Since the image light reflected by the concave mirror 160 is reflected by the PBS film 140, when a space inside the optical unit 100 is divided into two regions (a region A and a region B) by an extended surface (S_{PBS}) of the PBS film 140, the eyepiece lens 200 is provided in the region (the region A) on the same side as the concave mirror 160.

### (Operations and Effects)

According to the optical unit 100 of the second embodiment, the same effects as those of the first embodiment can be achieved even if the image light passed through the pin hole 131 provided in the diaphragm 130 is the P-polarized light.

### Third Embodiment

Hereinafter, a third embodiment will be described with reference to the drawing. The following description will be mainly given of differences between the first embodiment described above and the third embodiment.

Specifically, in the first embodiment described above, the image light reflected by the concave mirror 160 is transmitted through the PBS film 140 and then applied directly to the eyepiece lens 200. On the other hand, in the third embodiment, image light reflected by a concave mirror 160 is reflected again by a reflecting mirror and then applied to an eyepiece lens 200.

### (Configuration of Optical Unit)

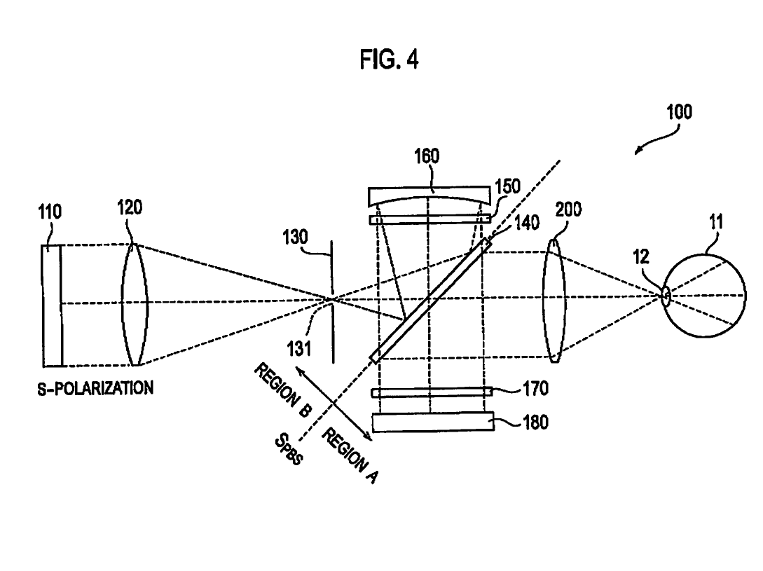

Hereinafter, a configuration of an optical unit according to the third embodiment will be described with reference to the drawing. FIG. 4 is a diagram showing a configuration of an optical unit 100 according to the third embodiment. It should be noted that, in FIG. 4, the same parts as those shown in FIG. 2 are denoted by the same reference numerals.

As shown in FIG. 4, the optical unit 100 includes a ¼λ-retardation film 170 and a reflecting mirror 180 in addition to the configuration shown in FIG. 2.

As shown in FIG. 4, a liquid crystal panel 110 emits S-polarized image light and a condenser lens 120 condenses the S-polarized image light on a pin hole 131.

The ¼λ-retardation film 170 is a retardation film configured to convert the polarization state of the light from linear polarization to circular polarization and to convert the polarization state of the light from circular polarization to linear polarization, as in the case of the ¼λ-retardation film 150. Since the image light reflected by the concave mirror 160 and then transmitted through the ¼λ-retardation film 150 is P-polarized light, the ¼λ-retardation film 170 is provided at a position opposed the concave mirror 160 across the PBS film 140.

The reflecting mirror 180 is a plane mirror configured to reflect the image light transmitted through the ¼λ-retardation film 170 toward the ¼λ-retardation film 170.

As described above, the image light transmitted through the PBS film 140 is transmitted through the ¼λ-retardation film 170, reflected by the reflecting mirror 180 and then transmitted again through the ¼λ-retardation film 170. In other words, the image light transmitted through the PBS film 140 is transmitted twice through the ¼λ-retardation film 170. Accordingly, a polarization direction of the image light is rotated approximately 90° and the polarization state of the image light is changed from S-polarization to P-polarization or from P-polarization to S-polarization.

Therefore, the polarization direction of the image light reflected by the reflecting mirror 180 and then transmitted again through the ¼λ-retardation film 170 is an S-polarization direction. As a result, the image light reflected by the reflecting mirror 180 is reflected by the PBS film 140.

Note that, since the image light reflected by the reflecting mirror 180 is reflected by the PBS film 140, when a space inside the optical unit 100 is divided into two regions (a region A and a region B) by an extended surface (S_{PBS}) of the PBS film 140, the eyepiece lens 200 is provided in the region (the region A) on the same side as the reflecting mirror 180.

### (Operations and Effects)

The optical unit 100 according to the third embodiment makes it possible to secure a sufficient optical path length between the diaphragm 130 and the eyepiece lens 200, while an increase in the device size is further suppressed, since the image light is reflected by the reflecting mirror 180 in addition to the configuration of the first embodiment. Furthermore, the optical unit 100 employs a configuration in which the image light is transmitted twice through the ¼λ-retardation film 170 so as to allow the ¼λ-retardation film 170 to convert the polarization state of the image light from linear polarization to circular polarization and then to convert the polarization state of the image light from circular polarization to linear polarization. By employing such a configuration, the polarization state of the image light is rotated approximately 90° and the image light converted from S-polarized light into P-polarized light or the image light converted from P-polarized light into S-polarized light can be extracted.

### Fourth Embodiment

Hereinafter, a fourth embodiment will be described with reference to the drawing. The following description will be mainly given of differences between the third embodiment described above and the fourth embodiment.

In the third embodiment described above, the image light emitted from the liquid crystal panel 110 (the image light passed through the pin hole 131) is the S-polarized ligh. On the other hand, in the fourth embodiment, image light emitted from a liquid crystal panel 110 (image light passed through a pin hole 131) is P-polarized light.

### (Configuration of Optical Unit)

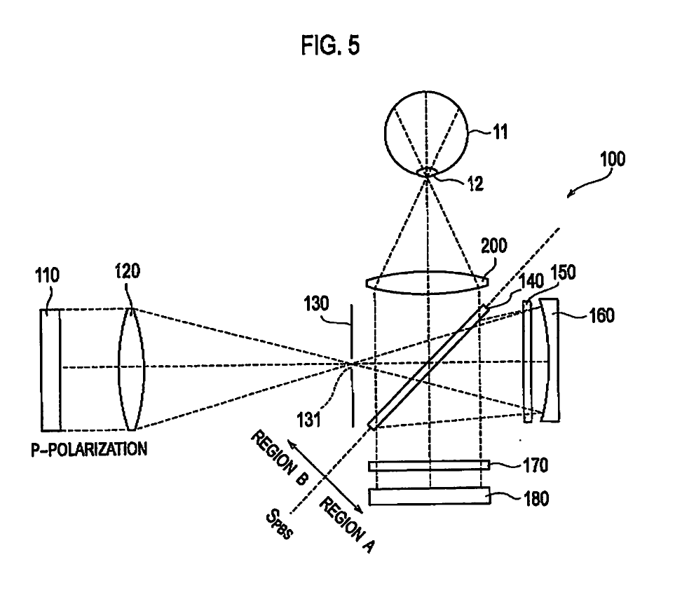

Hereinafter, a configuration of an optical unit according to the fourth embodiment will be described with reference to the drawing. FIG. 5 is a diagram showing a configuration of an optical unit 100 according to the fourth embodiment. It should be noted that, in FIG. 5, the same parts as those shown in FIG. 4 are denoted by the same reference numerals.

As shown in FIG. 5, the liquid crystal panel 110 emits P-polarized image light and a condenser lens 120 condenses the P-polarized image light on the pin hole 131.

A ¼λ-retardation film 170 is a retardation film configured to convert the polarization state of the light from linear polarization to circular polarization and to convert the polarization state of the light from circular polarization to linear polarization, as in the case of the ¼λ-retardation film 150. Since the image light reflected by a concave mirror 160 and then transmitted through the ¼λ-retardation film 150 is S-polarized light, when a space inside the optical unit 100 is divided into two regions (a region A and a region B) by an extended surface (S_{PBS}) of the PBS film 140, the ¼λ-retardation film 170 is provided in the region (the region A) on the same side as the concave mirror 160.

As described above, the image light reflected by the PBS film 140 is transmitted through the ¼λ-retardation film 170, reflected by a reflecting mirror 180 and then transmitted again through the ¼λ-retardation film 170. In other words, the image light reflected by the PBS film 140 is transmitted twice through the ¼λ-retardation film 170. Accordingly, a polarization direction of the image light is rotated approximately 90° and the polarization state of the image light is changed from S-polarization to P-polarization or from P-polarization to S-polarization.

Therefore, the polarization direction of the image light reflected by the reflecting mirror 180 and then transmitted again through the ¼λ-retardation film 170 is a P-polarization direction. As a result, the image light reflected by the reflecting mirror 180 is transmitted through the PBS film 140.

Note that, since the image light reflected by the reflecting mirror 180 is transmitted through the PBS film 140, the eyepiece lens 200 is provided at a position opposed the reflecting mirror 180 across the PBS film 140.

### (Operations and Effects)

According to the optical unit 100 of the fourth embodiment, the same effects as those of the third embodiment can be achieved even if the image light passed through the pin hole 131 provided in the diaphragm 130 is the P-polarized light.

### Fifth Embodiment

Hereinafter, a fifth embodiment will be described with reference to the drawing. The following description will be mainly given of differences between the first embodiment described above and the fifth embodiment.

Specifically, in the first embodiment described above, the light emitted from the liquid crystal panel 110 is condensed an the pin hole 131 by the condenser lens 120. On the other hand, in the fifth embodiment, light emitted from a liquid crystal panel 110 is condensed on a pin hole 131 by a PBS film, a ¼λ-retardation film and a concave mirror

### (Configuration of Optical Unit)

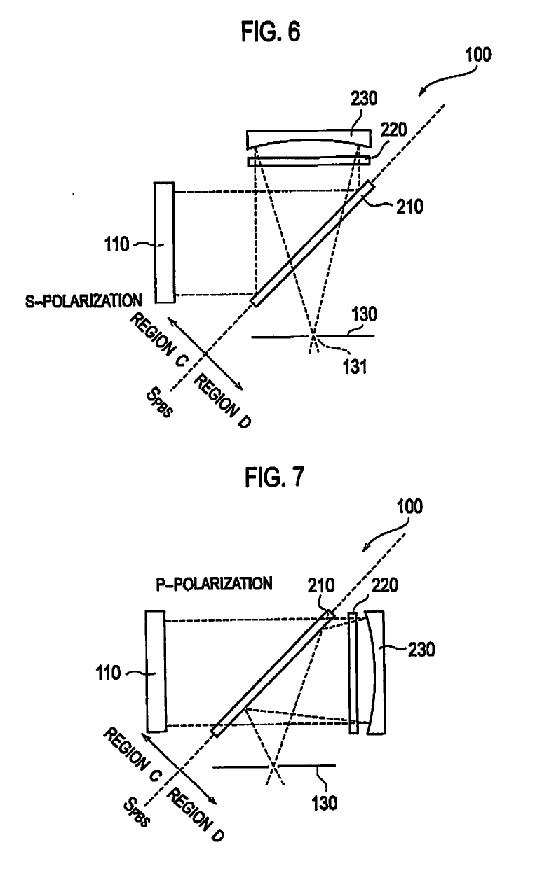

Hereinafter, a configuration of an optical unit according to the fifth embodiment will be described with reference to the drawing. FIG. 6 is a diagram showing a configuration of an optical unit 100 according to the fifth embodiment. It should be noted that, in FIG. 6, the same parts as those shown in FIG. 2 are denoted by the same reference numerals. Note that FIG. 6 shows only a configuration from the liquid crystal panel 110 to a diaphragm 130 and a configuration from the diaphragm 130 to an eyepiece lens 200 is omitted therein.

As shown in FIG. 6, the optical unit 100 includes a PBS film 210, a ¼λ-retardation film 220 and a concave mirror 230. Note that the liquid crystal panel 110 emits S-polarized image light.

The PBS film 210 is a PBS (Polarized Beam Splitter) film configured to separate the light into reflected light and transmitted light according to a polarization direction of the light. The PBS film 210 has a tilt of approximately 45° with respect to an optical axis of the image light emitted from the liquid crystal panel 110. Note that the PBS film 210 reflects the S-polarized image light emitted from the liquid crystal panel 110 toward the concave mirror 230, and transmits P-polarized image light returned after being reflected by the concave mirror 230 therethrough toward the diaphragm 130.

The ¼λ-retardation film 220 converts the polarization state of the image light reflected by the PBS film 210 from linear polarization to circular polarization, and converts the polarization state of the light from circular polarization to linear polarization. Since the image light emitted from the liquid crystal panel 110 is S-polarized light, when a space inside the optical unit 100 is divided into two regions (a region C and a region D) by an extended surface (S_{PBS}) of the PBS film 210, the ¼λ-retardation film 220 is provided in the region (the region C) on the same side as the liquid crystal panel 110.

The concave mirror 230 reflects the image light transmitted through the ¼λ-retardation film 220 toward the ¼λ-retardation film 220. The concave mirror 230 focuses the image light on the pin hole 131 provided in the diaphragm 130 by reflecting the image light.

As described above, the image light reflected by the PBS film 210 is transmitted through the ¼λ-retardation film 220, reflected by the concave mirror 230 and then transmitted again through the ¼λ-retardation film 220. In other words, the image light reflected by the PBS film 210 is transmitted twice through the ¼λ-retardation film 220. Accordingly, the polarization direction of the image light is rotated approximately 90° and the polarization state of the image light is changed from S-polarization to P-polarization or from P-polarization to S-polarization.

Therefore, the polarization direction of the image light reflected by the concave mirror 230 and then transmitted again through the ¼λ-retardation film 220 is a P-polarization direction. As a result, the image light reflected by the concave mirror 230 is transmitted through the PBS film 210.

Note that, since the image light reflected by the concave mirror 230 is transmitted through the PBS film 210, the diaphragm 130 is provided at a position opposed the concave mirror 230 across the PBS film 210.

### (Operations and Effects)

The optical unit 100 according to the fifth embodiment makes it possible to increase an optical path length between the liquid crystal panel 110 and the diaphragm 130, while an increase in a device size is suppressed, since the concave mirror 230 reflects the image light and then focuses the image light on the pin hole 131 provided in the diaphragm 130. Furthermore, the optical unit 100 employs a configuration in which the image light is transmitted twice through the ¼λ-retardation film 220 so as to allow the ¼λ-retardation film 220 to convert the polarization state of the image light from linear polarization to circular polarization and then to convert the polarization state of the image light from circular polarization to linear polarization. By employing such a configuration, the polarization state of the image light is rotated approximately 90° and the image light converted from S-polarized light into P-polarized light or the image light converted from P-polarized light into S-polarized light can be extracted.

### Sixth Embodiment

Hereinafter, a sixth embodiment will be described with reference to the drawing. The following description will be mainly given of differences between the fifth embodiment described above and die sixth embodiment.

Specifically, in the fifth embodiment described above, the image light emitted from the liquid crystal panel 110 is the S-polarized light. On the other hand, in the sixth embodiment, image light emitted from a liquid crystal panel 110 is P-polarized light.

### (Configuration of Optical Unit)

Hereinafter, a configuration of an optical unit according to the sixth embodiment will be described with reference to the drawing. FIG. 7 is a diagram showing a configuration of an optical unit 100 according to the sixth embodiment. It should be noted that, in FIG. 7, the same parts as those shown in FIG. 2 are denoted by the same reference numerals. Note that FIG. 7 shows only a configuration from the liquid crystal panel 110 to a diaphragm 130 and a configuration from the diaphragm 130 to an eyepiece lens 200 is omitted therein. Moreover, the liquid crystal panel 110 emits P-polarized image light.

As shown in FIG. 7, a PBS film 210 has a tilt of approximately 45° with respect to an optical axis of the image light emitted from the liquid crystal panel 110. Note that the PBS film 210 transmits the P-polarized image light emitted from the liquid crystal panel 110 therethrough toward a concave mirror 230 and reflects S-polarized image light returned after being reflected by the concave mirror 230 toward the diaphragm 130.

A ¼λ-retardation film 220 converts the polarization state of the image light transmitted through the PBS film 210 from linear polarization to circular polarization and converts the polarization state of the light from circular polarization to linear polarization. Since the image light emitted from the liquid crystal panel 110 is P-polarized light, the ¼λ-retardation film 220 is provided at a position opposed the liquid crystal panel 110 across the PBS film 210.

The concave mirror 230 reflects the image light transmitted through the ¼λ-retardation film 220 toward the ¼λ-retardation film 220. The concave mirror 230 focuses the image light on the pin hole 131 provided in the diaphragm 130 by reflecting the image light.

As described above, the image light transmitted through the PBS film 210 is transmitted through the ¼λ-retardation film 220, reflected by the concave mirror 230 and then transmitted again through the ¼λ-retardation film 220. In other words, the image light transmitted through the PBS film 210 is transmitted twice through the ¼λ-retardation film 220. Accordingly, the polarization direction of the image light is rotated approximately 90° and the polarization state of the image light is changed from S-polarization to P-polarization or from P-polarization to S-polarization.

Therefore, the polarization direction of the image light reflected by the concave mirror 230 and then transmitted again through the ¼λ-retardation film 220 is an S-polarization direction. As a result, the image light reflected by the concave mirror 230 is reflected by the PBS film 210.

Note that, since the image light reflected by the concave mirror 230 is reflected by the PBS film 210, when a space inside the optical unit 100 is divided into two regions (a region C and a region D) by an extended surface (S_{PBS}) of the PBS film 210, the diaphragm 130 is provided in the region (the region D) on the same side as the concave mirror 230.

### (Operations and Effects)

According to the optical unit 100 of the sixth embodiment, the same effects as those of the fifth embodiment can be achieved even if the image light emitted from the liquid crystal panel 110 is the P-polarized light.

### Seventh Embodiment

Hereinafter, a seventh embodiment will be described with reference to the drawing. The following description will be mainly given of differences between the fifth embodiment described above and the seventh embodiment.

Specifically, in the fifth embodiment described above, the image light reflected by the concave mirror 230 is focused on the pin hole 131 provided in the diaphragm 130 and then directly extracted. On the other hand, in the seventh embodiment, image light reflected by a concave mirror 230 is focused on a pin hole 131 provided in a diaphragm 130, reflected by a minuscule mirror and then extracted.

### (Configuration of Optical Unit)

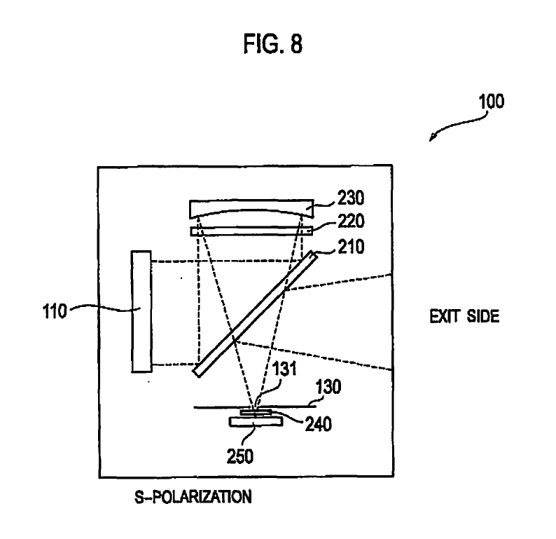

Hereinafter, a configuration of an optical unit according to the seventh embodiment will be described with reference to the drawing. FIG. 8 is a diagram showing a configuration of an optical unit 100 according to the seventh embodiment. It should be noted that, in FIG. 8, the same parts as those shown in FIG. 2 are denoted by the same reference numerals. Note that FIG. 8 shows only a configuration from a liquid crystal panel 110 to a diaphragm 130 and a configuration from the diaphragm 130 to an eyepiece lens 200 is omitted therein.

As shown in FIG. 8, the optical unit 100 includes a ¼λ-retardation film 240 and a minuscule mirror 250 in addition to the configuration shown in FIG. 6. Note that the liquid crystal panel 110 emits S-polarized image light.

The ¼λ-retardation film 240 is a retardation film configured to convert the polarization state of the light from linear polarization to circular polarization, and to convert the polarization state of the light from circular polarization to linear polarization, as in the case of the ¼λ-retardation film 150. Since the image light reflected by the concave mirror 230 and then transmitted through the ¼λ-retardation film 220 is P-polarized light, the ¼λ-retardation film 240 is provided at a position opposed the concave mirror 230 across the PBS film 210. Note that, since the image light is focused on the pin hole 131 provided in the diaphragm 130, it is only necessary for the ¼λ-retardation film 240 to have a size for covering the pin hole 131. In terms of effective utilization of the image light and size reduction, it is preferable that the ¼λ-retardation film 240 should be disposed close to the pin hole 131.

The minuscule mirror 250 is a plane mirror configured to reflect the image light transmitted through the ¼λ-retardation film 240 toward the ¼λ-retardation film 240. Note that, since the image light is focused on the pin hole 131 provided in the diaphragm 130, it is only necessary for the minuscule mirror 250 to have a size for covering the pin hole 131 as in the case of the ¼λ-retardation film 240. In terms of effective utilization of the image light and size reduction, it is preferable that the minuscule mirror 250 should be disposed close to the pin hole 131.

As described above, the image light transmitted through the PBS film 210 is transmitted through the ¼λ-retardation film 240, reflected by the minuscule mirror 250 and then transmitted again through the ¼λ-retardation film 240. In other words, the image light transmitted through the PBS film 210 is transmitted twice through the ¼λ-retardation film 240. Accordingly, a polarization direction of the image light is rotated approximately 90° and the polarization state of the image light is changed from S-polarization to P-polarization or from P-polarization to S-polarization.

Therefore, the polarization direction of the image light reflected by the minuscule mirror 250 and then transmitted again through the ¼λ-retardation film 240 is an S-polarization direction. As a result, the image light reflected by the minuscule mirror 250 is reflected by the PBS film 210.

As shown in FIG. 8, it is preferable that the liquid crystal panel 110, the diaphragm 130, the PBS film 210, the ¼λ-retardation film 220, the concave mirror 230, the ¼λ-retardation film 240 and the minuscule mirror 250 should be unitized.

### (Operations and Effects)

The optical unit 100 according to the seventh embodiment makes it possible to increase an optical path length between the liquid crystal panel 110 and the diaphragm 130, while an increase in a device size is further suppressed, since the minuscule mirror 250 reflects the image light in addition to the configuration of the fifth embodiment. Furthermore, the optical unit 100 employs a configuration in which the image light is transmitted twice through the ¼λ-retardation film 240 so as to allow the ¼λ-retardation film 240 to convert the polarization state of the image light from linear polarization to circular polarization and then to convert the polarization state of the image light from circular polarization to linear polarization. By employing such a configuration, the polarization state of the image light is rotated approximately 90° and the image light converted from S-polarized light into P-polarized light or the image light converted from P-polarized light into S-polarized light can be extracted.

### Eighth Embodiment

Hereinafter, an eighth embodiment will be described with reference to the drawing. The eighth embodiment is an embodiment obtained by combining the fourth and fifth embodiments described above.

### (Configuration of Optical Unit)

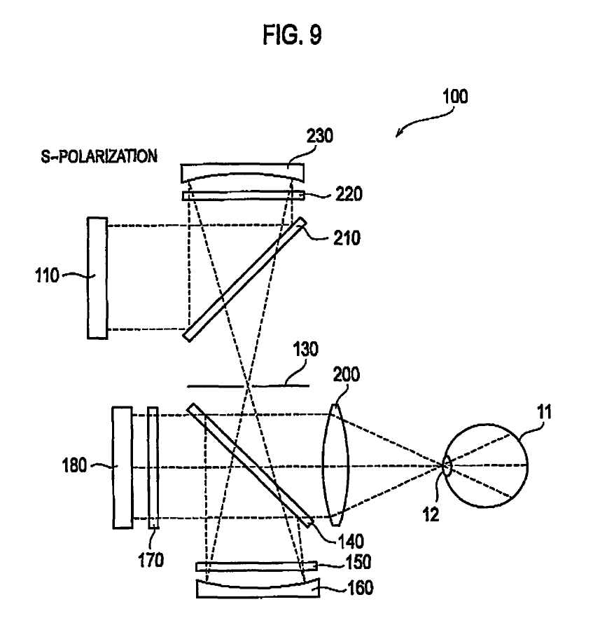

Hereinafter, a configuration of an optical unit according to the eighth embodiment will be described with reference to the drawing. FIG. 9 is a diagram showing a configuration of an optical unit 100 according to the eighth embodiment. It should be noted that, in FIG. 9, the same parts as those shown in FIGS. 5 and 6 are denoted by the same reference numerals.

As shown in FIG. 9, the optical unit 100 has the configuration shown in FIG. 5 and the configuration shown in FIG. 6. Specifically, the optical unit 100 has the configuration shown in FIG. 6 as the configuration from the liquid crystal panel 110 to the diaphragm 130 and has the configuration shown in FIG. 5 as the configuration from the diaphragm 130 to the eyepiece lens 200.

### Ninth Embodiment

Hereinafter, a volume of a housing configured to house an optical unit 100 will be described with reference to the drawings. As a comparative example, an optical unit using no PBS film or ¼λ-retardation film will be described. As an example, the optical unit according to the eighth embodiment will be described. Here, the optical unit is a unit composed of optical elements from a liquid crystal panel to an eyepiece lens. Accordingly, the housing houses the optical elements from the liquid crystal panel to the eyepiece lens.

### (Comparative Example)

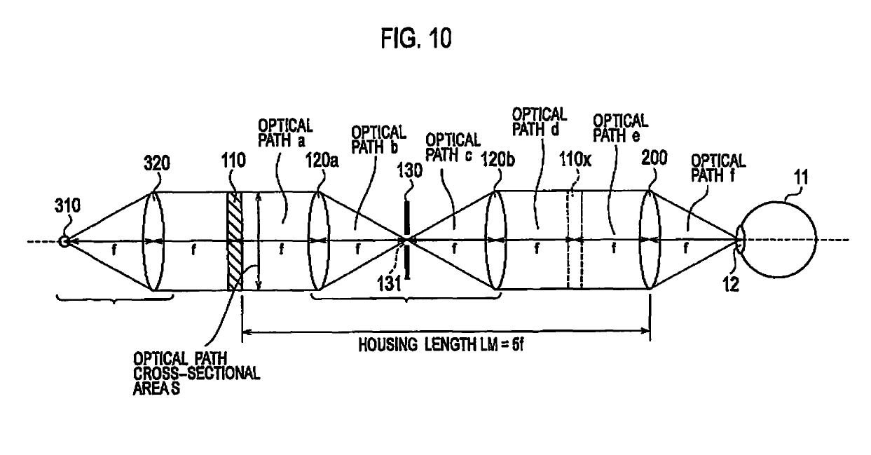

Hereinafter, the comparative example will be described with reference to FIG. 10. As shown in FIG. 10, in the comparative example, there are provided: a point light source 310 configured to emit light to be applied to a liquid crystal panel 110; and a lens 320 configured to convert the light emitted from the point light source 310 into parallel light.

The optical unit according to the comparative example includes the liquid crystal panel 110, a lens 120a, a lens 120b, a diaphragm 130 and an eyepiece lens 200. Since the liquid crystal panel 110, the diaphragm 130 and the eyepiece lens 200 have the same configurations as those of the embodiments described above, description thereof will be omitted.

The lens 120a and the lens 120b are a rediffraction optical system configured to roughly form, on an image plane 110x, an image formed on the liquid crystal panel 110. The diaphragm 130 is disposed so as to allow a pin hole 131 to overlap with a focal position of the lens 120a.

Here, a required length (a housing length LM) of the housing configured to house the optical unit is a sum of optical paths a to e, that is, “5f”. Here, “f” is a focal length of each of the lens 120a, the lens 120b and the eyepiece lens 200.

Therefore, the volume of the housing configured to house the optical unit is “S×LM=S×5f”. However, S is a cross-sectional area of a luminous flux emitted from the liquid crystal panel 110.

### EXAMPLE

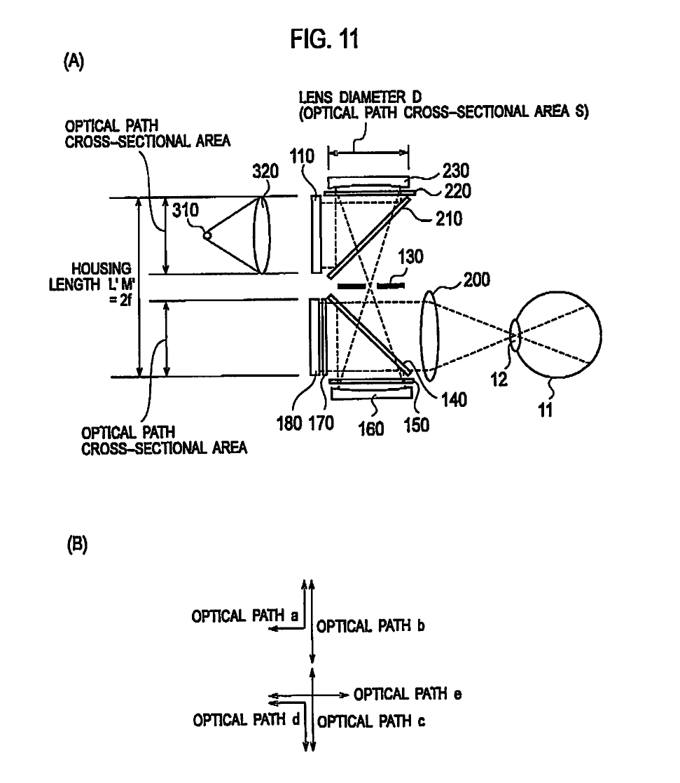

Hereinafter, the example will be described with reference to FIGS. 11 (A) and 11 (B). As shown in FIG. 11 (A), in the example, there are provided: a point light source 310 configured to emit light to be applied to a liquid crystal panel 110; and a lens 320 configured to convert the light emitted from the point light source 310 into parallel light.

An optical unit 100 according to the example includes the liquid crystal panel 110, a PBS film 210, a ¼λ-retardation film 220, a concave mirror 230, a diaphragm 130, a PBS film 140, a ¼λ-retardation film 150, a concave mirror 160, a ¼λ-retardation film 170, a reflecting mirror 180 and an eyepiece lens 200, as in the case of the eighth embodiment. Since the optical elements have the same configurations as those of the eighth embodiment described above, description thereof will be omitted.

In the optical unit 100 according to the example, as shown in FIGS. 11 (A) and 11 (B), optical paths a and b are superimposed by the PBS film 210 and optical paths c to e are superimposed by the PBS film 140.

Here, a required length (a housing length L′M′) of the housing configured to house the optical unit 100 is “2f”. Here, “f” is a focal length of each of the lens 120a, the concave mirror 160 and the concave mirror 230. Note that each of the lens 120a, the concave mirror 160 and the concave mirror 230 is assumed to have an F number of “1”.

Therefore, the volume of the housing configured to house the optical unit 100 is “S×LM=S×2f”. However, S is a cross-sectional area of a luminous flux emitted from the liquid crystal panel 110.

### Comparison Between Comparative Example and Example

As described above, the optical path length from the liquid crystal panel 110 to the eyepiece lens 200 in the example is equal to the optical path length from the liquid crystal panel 110 to the eyepiece lens 200 in the comparative example. On the other hand, the required length (the housing length L′M′) of the housing configured to house the optical unit 100 according to the example is smaller than the required length (the housing length LM) of the housing configured to house the optical unit according to the comparative example.

As a result, the volume of the housing configured to house the optical unit 100 according to the example is smaller than the volume of the housing configured to house the optical unit according to the comparative example. Specifically, the volume of the housing according to the example is ⅖ of the volume of the housing according to the comparative example.

### Tenth Embodiment

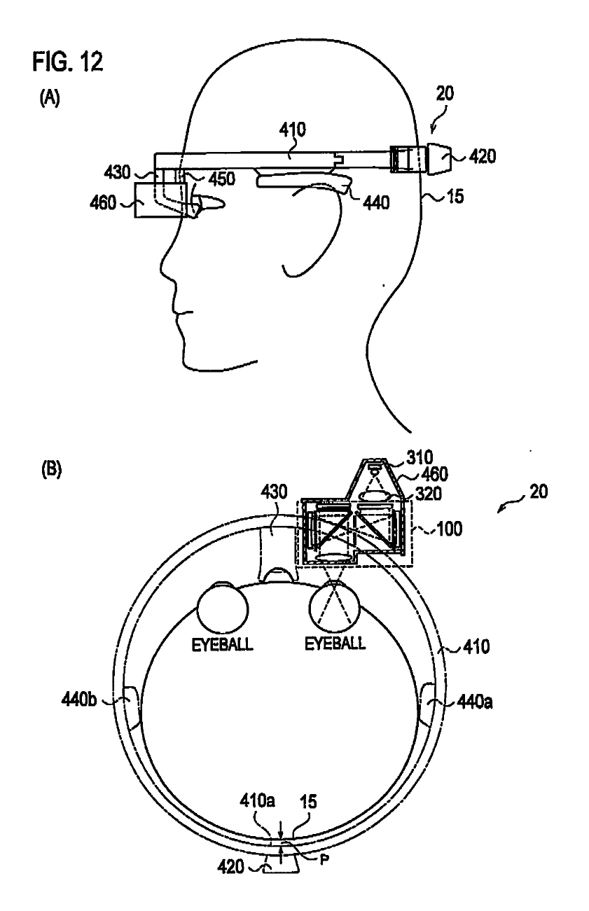

Hereinafter, With reference to FIGS. 12 (A) and 12 (B), a tenth embodiment will be described with reference to FIGS. 12 (A) and 12 (B). FIG. 12 (A) is a side view of a head mounted display apparatus 20 and FIG. 12 (B) is a top view of the head mounted display apparatus 20.

As shown in FIGS. 12 (A) and 12 (B), the head mounted display apparatus 20 includes an annular member 410, an adjuster 420, a nose pad 430, ear pads 440 (an ear pad 440a and an ear pad 440b), a connection member 450 and a display unit 460.

The annular member 410 is a member mounted on the head of a user 10 and has an annular shape. The annular member 410 is made of plastic resin or the like.

The adjuster 420 is provided in the annular member 410 on a back 15 side of the head of the user 10 and adjusts a gap p formed between the back 15 of the head of the user 10 and an inner surface 410a of the annular member 410. For example, the adjuster 420 is configured to adjust a size of the annular member 410 so as to reduce an inside diameter of the inner surface 410a. The adjuster 420 may also be configured to push a back pad provided inside the inner surface 410a against the back 15 of the head.

The nose pad 430 is a pad provided downward from the annular member 410 in front of the head of the user 10 and pressed against the nose (the bridge of the nose). The head mounted display apparatus 20 is supported on the nose by the nose pad 430.

The ear pads 440 are pads provided to extend downward from the annular member at the lateral sides of the head of the user 10 and pressed against bases of the ears. The head mounted display apparatus 20 is supported on the bases of the ears by the ear pads 440.

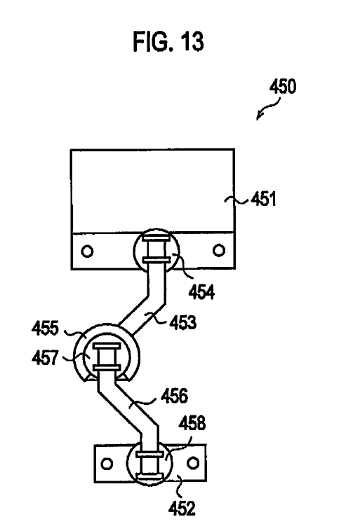

The connection member 450 is provided downward from the annular member 410 in front of the head of the user 10 and connects the annular member 410 with the display unit 460. Specifically, as shown in FIG. 13, the connection member 450 includes an attachment 451, an attachment 452, an arm 453 and an arm 456.

The attachment 451 is a member screwed or bonded to the annular member 410. The attachment 451 rotatably supports a rotary ball 454 provided in the arm 453.

The attachment 452 is a member screwed or bonded to the display unit 460. The attachment 452 is rotatably supported by a rotary ball 458 provided in the arm 456.

The arm 453 is rotatably supported by the attachment 451 and has a conical range of movement. Specifically, the arm 453 has the rotary ball 454 and a ball support 455. The rotary ball 454 has a spherical shape. The ball support 455 rotatably supports a rotary ball 457 provided in the arm 456.

The arm 456 is rotatably supported by the arm 453 and has a conical range of movement. Specifically, the arm 456 has the rotary ball 457 and the rotary ball 458. Each of the rotary balls 457 and 458 has a spherical shape.

The display unit 460 is a unit composed of a point light source 310, a lens 320, an optical unit 100 and the like. The display unit 460 is disposed in front of an eyeball 11 of the user 10 in a state where the annular member 410 is mounted on the head of the user 10.

As the optical unit 100, the optical unit according to any one of the first to eighth embodiments described above can be used. Note that FIG. 12 (B) shows the optical unit according to the eighth embodiment described above.

As described above, the head mounted display apparatus 20 is supported on four points, including the back 15 of the head of the user 10, the nose of the user 10 and the bases of the both ears of the user 10. Therefore, even if the display unit 460 has a certain weight, the display unit 460 is prevented from being shifted from the front of the eyeball 11 of the user 10.

The arm 453 is rotatably supported on the annular member 410 (the attachment 451) by the rotary ball 454, and the arm 456 is rotatably supported on the arm 453 by the rotary ball 457. The display unit 460 is rotatably supported on the connection member 450 (the attachment 452) by the rotary ball 458. Therefore, a position of the display unit 460 can be finely adjusted so as to dispose the display unit 460 in front of the eyeball 11 of the user 10.

### Eleventh Embodiment

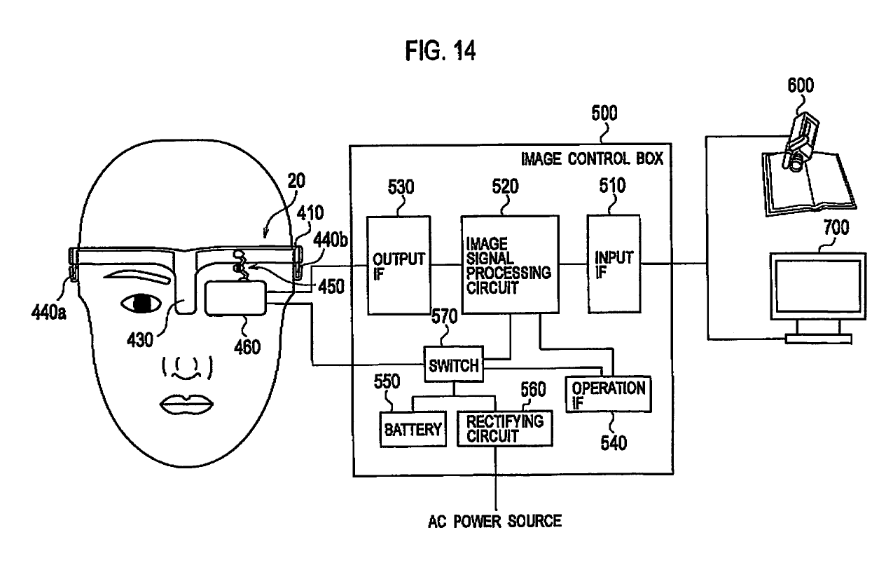

Hereinafter, an eleventh embodiment will be described with reference to FIG. 14. FIG. 14 is a diagram showing an image display system including the head mounted display apparatus 20.

As shown in FIG. 14, in the image display system, an image control BOX 500 is connected to the head mounted display apparatus 20 described above.

The image control BOX 500 includes an input IF 510, an image signal processing circuit 520, an output IF 530, an operation IF 540, a battery 550, a rectifying circuit 560 and a switch 570.

The input IF 510 receives an image input signal inputted from an external device (for example, a camera 600 or a TV 700) and the like.

The image signal processing circuit 520 converts the image input signal into an image output signal. Specifically, the image signal processing circuit 520 converts the image input signal into an image output signal applicable to the head mounted display apparatus 20.

For example, the image signal processing circuit 520 includes a γ correction circuit, a signal conversion circuit, a decoding circuit and the like. The γ correction circuit is a circuit configured to convert an image input signal into an image output signal according to a γ curve set depending on the liquid crystal panel 110 provided in the head mounted display apparatus 20. The signal conversion circuit is, for example, a circuit configured to convert an RGB signal into a component signal, a circuit configured to convert a component signal into an RGB signal, a YC separation circuit or the like. The decoding circuit is a circuit configured to decode an image input signal according to MPEG2, MPEG4 or the like specified by MPEG (Moving Picture Experts Group).

The output IF 530 outputs, to the head mounted display apparatus 20, the image output signal converted by the image signal processing circuit 520.

The operation IF 540 is a human interface composed of operation buttons and the like. For example, the user 10 can play images forward, stop the images, play the images backward, switch between color and monochrome, invert black and white colors, and the like by operating the operation IF 540.

The battery 550 is a battery configured to be able to accumulate power to be supplied to the display unit 460 and the image control BOX 500. The rectifying circuit 560 is a circuit configured to rectify AC power into DC power.

The switch 570 switches a power source for supplying power to the display unit 460 and the image control BOX 500. For example, when an AC power source can be acquired, the switch 570 connects the rectifying circuit 560 to the display unit 460 and the image control BOX 500. On the other hand, when the AC power source cannot be acquired, the switch 570 connects the battery 550 to the display unit 460 and the image control BOX 500. Note that the switch 570 may switch the power source according to the operation performed by the user 10.

### OTHER EMBODIMENTS

As described above, the contents of the present invention have been described through the above embodiments of the present invention. However, it should be understood that the present invention is not limited to the description and drawings which constitute a part of this disclosure. From this disclosure, various alternative embodiments, examples and operational techniques will become apparent to those skilled in the art.

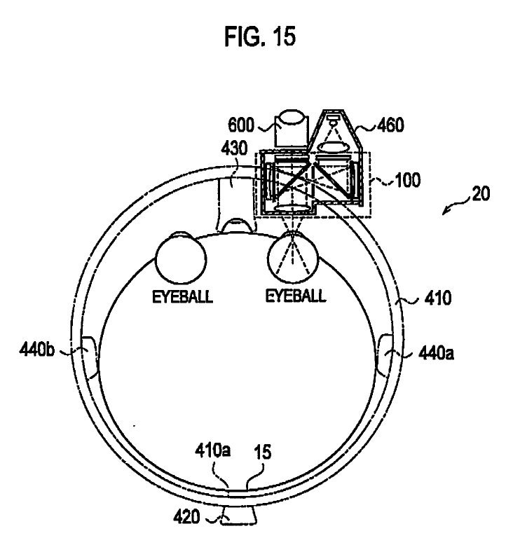

For example, as shown in FIG. 15, a head mounted display apparatus 20 includes a camera 600 in front of an eyeball 11 of a user 10. The camera 600 is provided in a display unit 460. As the camera 600, a small camera such as a CCD camera is preferably used. The camera 600 is preferably provided on a line of sight of the user 10. In order to make the device applicable to a person with visual impairment such as squint, it is preferable that the display unit 460 should rotatably support the camera 600. In this case, it is preferable that the display unit 460 should support the camera 600 in such a manner that the display unit 460 (a liquid crystal panel 110) is provided in a direction in which the pupil of the user is pointed and the camera 600 is pointed toward a direction in which the face of the user is pointed.

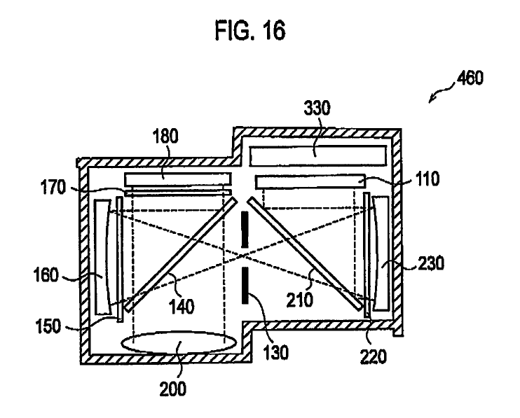

In the embodiments described above, the point light source 310 has been described as the light source for irradiating the liquid crystal panel 110 with light. However, the present invention is not limited thereto. Specifically, as shown in FIG. 16, a surface light source 330 may be used as the light source for irradiating the liquid crystal panel 110 with light. In such a case, it is preferable that the surface light source 330 should emit parallel light. Thus, a distance between the surface light source 330 and the liquid crystal panel 110 can be shortened and the display unit 460 can be miniaturized.

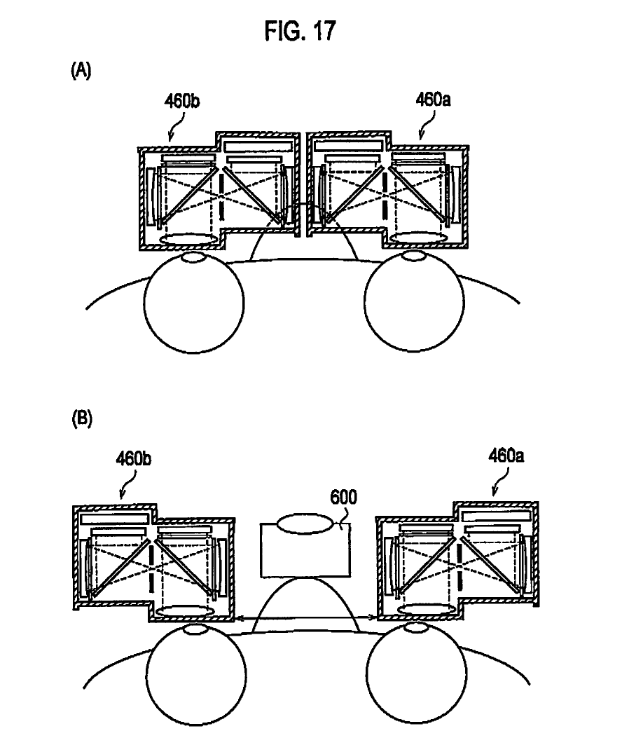

In the embodiments described above, the head mounted display apparatus 20 includes the display unit 460 corresponding to only one eye. However, the present invention is not limited thereto. Specifically, as shown m FIG. 17 (A), a head mounted display apparatus 20 may include a pair of display units 460 (a display unit 460a and a display unit 460b) corresponding to both eyes, respectively. As shown in FIG. 17 (B), a head mounted display apparatus 20 may include a camera 600 in addition to display units 460a and 460b. In such a case, the camera 600 is preferably disposed on the nose of the user 10. Note that the camera 600 may be supported by an annular member 410 provided in the head mounted display apparatus 20.

Combination of the configuration from the liquid crystal panel 110 to the diaphragm 130 and the configuration from the diaphragm 130 to the eyepiece lens 200 is not limited to that described in the eighth embodiment. Specifically, the optical unit 100 may have the configuration shown in FIG. 6 as the configuration from the liquid crystal panel 110 to the diaphragm 130 and have the configuration shown in FIG. 3 as the configuration from the diaphragm 130 to the eyepiece lens 200.

The optical unit 100 may have the configuration shown in FIG. 7 as the configuration from the liquid crystal panel 110 to the diaphragm 130 and have the configuration shown in FIG. 2 as the configuration from the diaphragm 130 to the eyepiece lens 200. The optical unit 100 may have the configuration shown in FIG. 7 as the configuration from the liquid crystal panel 110 to the diaphragm 130 and have the configuration shown in FIG. 4 as the configuration from the diaphragm 130 to the eyepiece lens 200.

In the embodiments described above, there is no particular mention of the type of the light source for irradiating the liquid crystal panel 110 with light. For example, a LED (light Emitting Diode), a LD (Laser Diode) and the like can be used as the light source.

In the embodiments described above, the description is given of the liquid crystal panel 110 as an example of the imager. However, the present invention is not limited thereto.

In the embodiments described above, there is no particular mention of the configuration from the light source to the liquid crystal panel 110. However, as a matter of course, an optical member configured to align a polarization direction of light emitted by the light source and an optical member configured to homogenize the light emitted by the light source may be provided.

### INDUSTRIAL APPLICABILITY

The present invention can provide an optical unit and a head mounted display apparatus which enable even a weak-eyesight person to see an image while an increase in the device size is suppressed.

1. An optical unit comprising:
an imager configured to emit image light;
a diaphragm having an aperture at a focal position where the image light emitted from the imager is focused;
a first PBS film having a tilt of approximately 45° with respect to an optical axis of the image light passed through the aperture;
a first retardation film having a tilt of approximately 90° with respect to the optical axis of the image light passed through the aperture, and being configured to convert the polarization state of the image light passed through the aperture from linear polarization to circular polarization;
a first concave mirror configured to reflect the image light transmitted through the first retardation film toward the first retardation film; and
an eyepiece lens configured to focus the image light reflected by the first concave mirror on an eyeball.

2. The optical unit according to claim 1, wherein,
when the image light passed through the aperture is S-polarized light, the eyepiece lens is provided at a position opposed the first concave mirror across the first PBS film.

3. The optical unit according to claim 1, wherein,
when the image light passed through the aperture is P-polarized light, the eyepiece lens is provided on the same side as the first concave mirror, the side being defined by the first PBS film as a boundary.

4. The optical unit according to claim 1, further comprising:
a second retardation film provided at a position opposed the first concave mirror across the first PBS film, when the image light passed through the aperture is S-polarized light, and being configured to convert the polarization state of the image light transmitted through the first PBS film from linear polarization to circular polarization; and
a reflecting mirror configured to reflect the image light transmitted through the second retardation film toward the second retardation film,
wherein, when the image light passed through the aperture is S-polarized light, the eyepiece lens is provided on the same side as the reflecting mirror, the side being defined by the first PBS film as a boundary.

5. The optical unit according to claim 1, further comprising:
a second retardation film provided on the same side as the first concave mirror, the side being defined by the first PBS film as a boundary, when the image light passed through the aperture is P-polarized light, and being configured to convert the polarization state of the image light reflected by the first PBS film from linear polarization to circular polarization; and
a reflecting mirror configured to reflect the image light transmitted through the second retardation film toward the second retardation film,
wherein, when the image light passed through the aperture is P-polarized light, the eyepiece lens is provided at a position opposed the reflecting mirror across the first PBS film.

6. The optical unit according to any one of claim 1, further comprising;
a second PBS film having a tilt of approximately 45° with respect to the optical axis of the image light emitted from the imager;
a third retardation film configured to convert the polarization state of the image light reflected by the second PBS film or the image light transmitted through the second PBS film from linear polarization to circular polarization; and
a second concave mirror configured to reflect the image light transmitted through the third retardation film toward the third retardation film,
wherein the second concave mirror focuses the image light on the aperture.

7. A head mounted display apparatus mounted on the head of a user, comprising:
an annular member having an annular shape mounted on the head of the user;
an adjuster provided in the annular member at the back side of the head of the user and being configured to adjust a gap formed between the back of the head of the user and an inner surface of the annular member;
a nose pad provided in the annular member at the front side of the head of the user and pressed against the nose of the user;
a display unit disposed in front of an eyeball of the user; and
a connection member provided in the annular member at the front side of the head of the user and being configured to connect the annular member with the display unit,
wherein the display unit includes
an imager configured to emit image light,
a light source configured to irradiate the imager with light,
a diaphragm having an aperture at a focal position where the image light emitted from the imager is focused,
a first PBS film having a tilt of approximately 45° with respect to an optical axis of the image light passed through the aperture,
a first retardation film having a tilt of approximately 90° with respect to the optical axis of the image light passed through the aperture, and being configured to convert the polarization state of the image light passed through the aperture from linear polarization to circular polarization,
a first concave mirror configured to reflect the image light transmitted through the first retardation film toward the first retardation film, and
an eyepiece lens configured to focus the image light reflected by the first concave mirror on the eyeball.

8. The head mounted display apparatus according to claim 7, further comprising;
ear pads provided to extend downward from the annular member at the lateral sides of the head of the user, and being pressed against the bases of the ears of the user.

9. The head mounted display apparatus according to claim 7, wherein
the connection member has a first arm provided on the annular member side and a second arm provided on the display unit side, and
the first arm rotatably supports the second arm.

10. The head mounted display apparatus according to claim 9, wherein
the annular member rotatably supports the first arm.

11. The head mounted display apparatus according to claim 9, wherein
the second arm rotatably supports the display unit.
